(19) United States
(12) Patent Application Publication
(10) Pub. No.: US 2005/0003828 A1
(43) Pub. Date: Jan. 6, 2005

(54) System and method for locating wireless devices in an unsynchronized wireless environment

(76) Inventors: Gary L. Sugar, Rockville, MD (US); David S. Kloper, Mt. Airy, MD (US)

Correspondence Address: COGNIO, INC., 101 ORCHARD RIDGE DRIVE, SUITE 350, GAITHERSBURG, MD, 20878, US

(21) Appl. No.: 10/409,563

(22) Filed: Apr. 8, 2003

Related U.S. Application Data
(60) Provisional application No. 60/370,725, filed on Apr. 9, 2002.
(60) Provisional application No. 60/319,737, filed on Nov. 27, 2002.

(51) Int. Cl. H04Q 7/20

(52) U.S. Cl. 455/456.1; 455/422.1

(57) ABSTRACT

A system and method for determining the location of a device (target device) in a wireless radio environment. The method involves transmitting a first signal. The target device transmits a second signal. The first signal and second signal are received at two or more known locations in the general proximity of the target device. The location of the target device is computed from the time difference of arrival of the first signal and arrival of the second signal at the two or more known locations. This technique does not require the measurements made at the known locations to be time-synchronized and, can be performed completely in software, if desired, using non-real-time post-processing.

This application claims priority to U.S. Provisional Application No. 60/370,725, filed Apr. 9, 2002, and to U.S. Provisional Application No. 60/319,737 filed Nov. 27, 2002, the entirety of each of which is incorporated herein by reference.

### BACKGROUND OF THE INVENTION

Many wireless radio communication applications involve multiple wireless devices communicating with each other or with a base station or hub device. For example, in a wireless local area network (WLAN), an access point (AP) communicates with multiple stations (STAs). STAs and APs may go on and off a network in a particular geographical locality. In order to manage access to the network for security and other purposes, it is desirable to know the location of a STA, AP or even another device that is not a WLAN device but is operating in the locality and frequency band of the WLAN. For example, if a rogue or untrusted STA or AP gains access to a large WLAN, it could possibly obtain secure or confidential information and/or disrupt operation of the WLAN. Therefore, it would be desirable to identify and locate the rogue device promptly. Similarly, if a non-WLAN device is operating in the locality of the WLAN and causing interference with WLAN operation, the location of that device would be useful information in terms of correcting the interference problem.

Radio location measurement techniques are known in the art. Many of these techniques require one or more of: recognition of special location signals, dedicated and cost-additive hardware resources, and higher speed processing in what is preferred to be a lower cost wireless device. For example, some location measurement techniques use time difference of arrival measurements made at several devices at known locations. However, the measurement at each known location must be time-synchronized, that is, the clock signals at the devices at the known locations must be synchronized, which adds significant complexity and, therefore, cost in order to support location measurement. What is needed is a location measurement technique that requires minimal modification of the signal processing used in the devices, and can be delivered to the market quickly and cost-effectively.

### SUMMARY OF THE INVENTION

Briefly, a system and method are provided for determining the location of a wireless radio device (target device or terminal) in a wireless radio communication environment. The method involves transmitting a first signal from a known or unknown location. The target device transmits a second signal which may or may not be responsive to the first signal. The first signal may precede or follow the second signal. Time of arrival measurements are made of the first signal second signal exchange at two or more known locations in the general proximity of the target device. For example, there is a reference device having a radio receiver at each of the two or more known locations. These reference devices receive and store data associated with the first signal-second signal exchange detected by their receivers. Alternatively, a known location may correspond to one antenna of a multi-antenna reference device. The location of the target device is computed from time difference of arrival measurements of the first signal and the second signal at two or more known locations. This technique does not require the measurements made at the known locations to be time-synchronized and, can be performed completely in software, if desired, using non-real-time post-processing.

The time difference of arrival measurements may be performed by cross-correlating the received waveform with a suitably long reference waveform. The noise averaging resulting from the long correlator enhances the measurement SNR, but does not increase the silicon area/device cost since the correlator may be implemented in software. The target device may, but is not required to, transmit a signal according to a communication standard or protocol used by the device that transmits the first signal. For example, one application of this technique is for measuring the position of an IEEE 802.11 STA or AP, for example, where the first signal is a request-to-send (RTS) packet addressed to the target device and the second signal is a clear-to-send (CTS) packet sent in reply to the RTS by the target device. However, this technique can be used to measure the position of any device that transmits a signal of any type, whether periodic or aperiodic, and regardless of whether the target device can decode or respond to the first signal when transmitting the second signal.

A further benefit of this location measurement technique is that the device to be located need not have any special hardware or software functionality. The computations and measurements may be made at other devices or locations.

Still another advantage of this location measurement technique is that all the location computations can be made at one computing device, not necessarily in real-time. Therefore, distributing specialized location measurement intelligence to several other devices is not necessary.

Other objects and advantages of the present invention will become more readily apparent when reference is made to the following description in conjunction with the accompanying drawings.

### BRIEF DESCRIPTION OF THE DRAWINGS

FIG. 1 is a block diagram of a wireless environment in which location measurement of terminals in a network may be useful.

FIG. 2 is an exemplary block diagram of a terminal that is useful in the location measurement techniques described herein.

FIG. 3 is a block diagram of one component useful in a terminal, where the component has a memory to store data useful in the location measurement techniques described herein.

FIG. 4 is a timing diagram showing a process for collecting location measurement data to locate a target terminal (TT).

FIGS. 5 and 6 are timing diagrams illustrating techniques to locate target terminals that do not necessarily obey the same communication protocol rules as a master reference terminal (MRT).

FIG. 7 is a timing diagram illustrating the length of the correlator waveform with respect to the received waveforms to be recognized.

FIG. 8 is a diagram illustrating the equations used to compute the location of a terminal using time difference of arrival measurements.

FIG. 9 is a block diagram of another type of terminal having multiple antennas that is useful for enhanced location measurement techniques.

FIG. 10 is a block diagram showing one of two possible positions of the TT with respect to a reference terminal (RT).

FIGS. 11 and 12 are block diagrams of other location measurement configurations possible with the use of terminals having multiple antennas.

FIG. 13 is a diagram showing a situation where the TT is located outside the normal coverage range of an RT or MRT.

FIG. 14 is a diagram showing an exemplary coverage map of a wireless network that can be created using the techniques described herein.

FIG. 15 is block diagram showing use of the location processes in a spectrum management system that manages activity in a frequency band.

### DETAILED DESCRIPTION OF THE DRAWINGS

The Location Measurement Process Generally

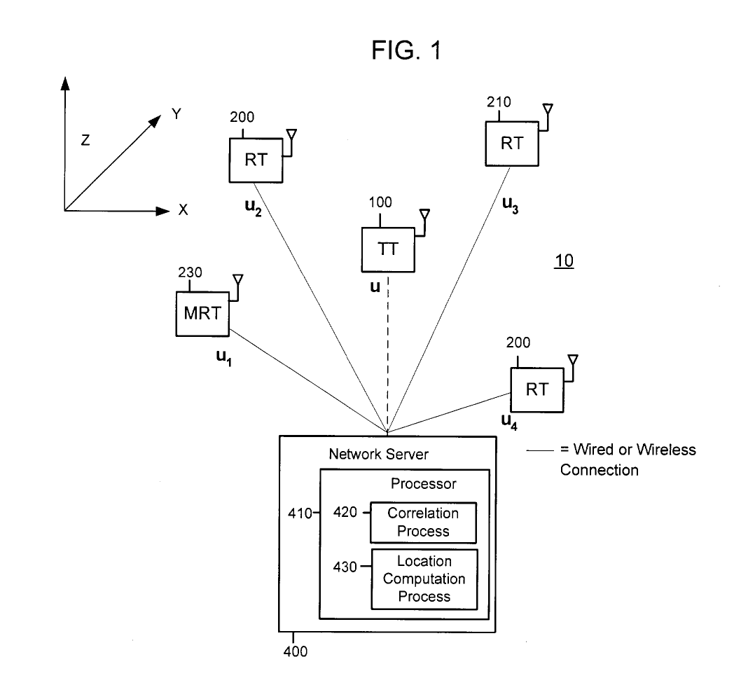

FIG. 1 illustrates a wireless radio environment 10 having multiple terminals. The environment 10 may be, for example, an IEEE 802.11 WLAN, and the terminals may be access points (APs) or stations (STAs). It is useful to know the location of various terminals for security and other network management reasons. A rogue device (STA or AP) may attempt to access the network, and if so, it would be desirable to locate it. Alternatively, the device to be located may be a non-WLAN device, such as a cordless phone, microwave oven, Bluetooth™ device, etc., that operates in the same frequency band as the WLAN terminals, potentially interfering with the WLAN operation. It would be desirable to locate an interfering device.

In FIG. 1, a target terminal (TT) 100 (AP, STA, cordless phone, etc.) is the device (also called a target device) whose location u is to be measured. There are one or more reference terminals (RTs) 200, 210 and 220 (e.g., AP or STA) each at a known location uᵢ=[xᵢ, yᵢ, zᵢ]), and a master reference terminal (MRT) 230 (e.g., AP or STA) at a known location u₁). Alternatively, as will be described hereinafter, the known location may consist of one antenna of a multi-antenna RT. A computing device, such as a network server (NS) 400, is coupled to each RT using a wired network connection or a wireless network connection directly or through one of the other terminals (such as the MRT 230) that may also act as an AP.

Generally, the location measurement process involves using time difference of arrival (TDOA) measurements at two or more known locations. Any terminal at a known or unknown location in the general proximity of the TT transmits a first radio signal. For example, the MRT 230 transmits a first (radio) signal. The TT 100 transmits a second (radio) signal. The first signal may be transmitted before or after the second signal. The arrival of the first signal and the second signal at two or more known locations (e.g., RTs including the MRT 230) is determined and a time difference is computed for each known location. The TDOA measurements are then used to compute the location of the TT 100. If the TT 100 is a type of device that can communicate with the MRT 230 according to a common communication standard, then the MRT 230 may address the first signal, which may be for example a request-to-send (RTS) packet, to the TT (using an address determined by the MR T 230 from other signals transmitted by TT 100 in the wireless network). Even though the first signal may be addressed to the TT 100, other terminals, such as the RTs, will nevertheless receive the first signal (although these other RTs will not respond to it because the first signal was not addressed to them). The TT 100 may transmit a second signal, which may be a clear-to-send (CTS) packet, in response to receiving the first signal, according to rules of the communication standard. The advantage of this process is that the clocks of the various devices used for measurement do not need to be synchronized, which in many cases would require additional hardware or software processing. Moreover, it is possible, but not required, to execute the computations performed by the location process entirely in non-real-time using software. This process may be performed in an indoor or outdoor wireless radio environment.

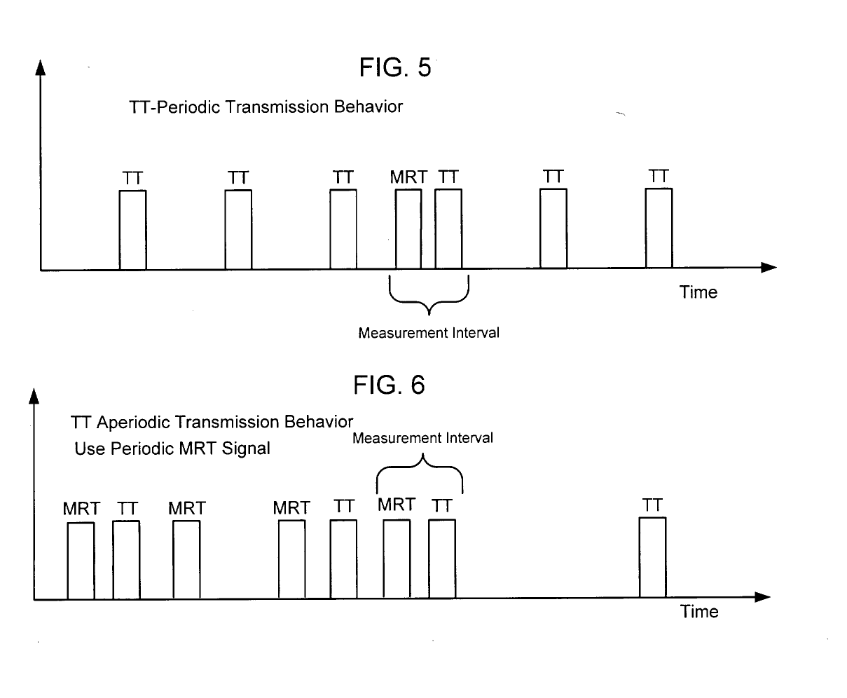

If the TT 100 does not communicate using the same communication standard as the MRT 230, but transmits a beacon signal, sync signal or other type of signal periodically or aperiodically, then the first signal (unaddressed to the TT) is transmitted and is used as a time reference with respect to a signal transmitted by the TT 100. These processes are described hereinafter in conjunction with FIGS. 5 and 6.

The locations of the MRT 230 and RTs 200, 210 and 220 are known through a priori knowledge, such as by physical measurement, through the use of global positioning systems (GPS) or through the use of the techniques described herein.

The NS 400 is a computing device (e.g., PC, server computer, etc.) that comprises a processor 410 and executes a location computation process 430 described hereinafter. The NS 410 may also execute a correlation process 420 that is described hereinafter. The correlation process 420 determines the time of arrival measurements of the various signals, and may also compute the TDOA data from the time of arrival data, or the TDOA computation is performed by a separate process. The location computation process 430 uses the TDOA data to compute the location of the TT 100. The correlation process for data collected at each of several RTs 200, 210 and 220, as suggested above, may be executed in the NS 400, or may be executed in the RTs 200, 210 and 220 themselves on an embedded or hosted processor. In any case, the computations that the RTs and/or NS perform may be done entirely in software and in non-real-time, saving significant costs in silicon area which would otherwise be required in a terminal device. The TDOA measurements may be computed by cross-correlating the received waveform with a very long reference waveform. Noise averaging due to a long correlator enhances the measurement SNR, but does not increase the silicon area/device cost since the correlator is implemented in software. An advantage of using a computing resource (and software) that may have greater processing capability than any of the RTs to perform the correlation process 420 and the location computation process 430 is that the RTs can be very inexpensive radio receiver devices, in a most basic form. In addition, the signals received by the RTs can be relatively weak because the correlation process 420 applied to that data can be powerful enough (since it can be executed on a computer, e.g., NS) to extract the important time of arrival information from the captured data at each RT. However, any RT (such as the MRT) that has sufficient processing capability may perform the correlation and even location measurement computations. The data or measurements at the other RTs would be sent to that RT.

One or more of the RTs 200, 210 and 220 and the MRT 230 shown in FIG. 1 have the capability of capturing and storing in a memory receive signal data output by the radio receiver of the device beginning at a specified time and for a specified time period. Terminals having this capability are hereinafter referred to as “collaborative” devices or terminals, and terminals that do not have this capability are referred to as non-collaborative devices or terminals.

The number of required time difference of arrival measurements at different known locations depends on the availability of other factors, but in general, measurements need to be made at at least two known locations. Table 1 below shows the number of measurements that are needed depending on other factors, such as whether one coordinate of the TT is known or the TT is a collaborative device. In all of the cases identified in the table below, there will be location ambiguity because the equations that are solved for the location computations will yield two solutions. The correct one of the two solutions needs to be chosen.

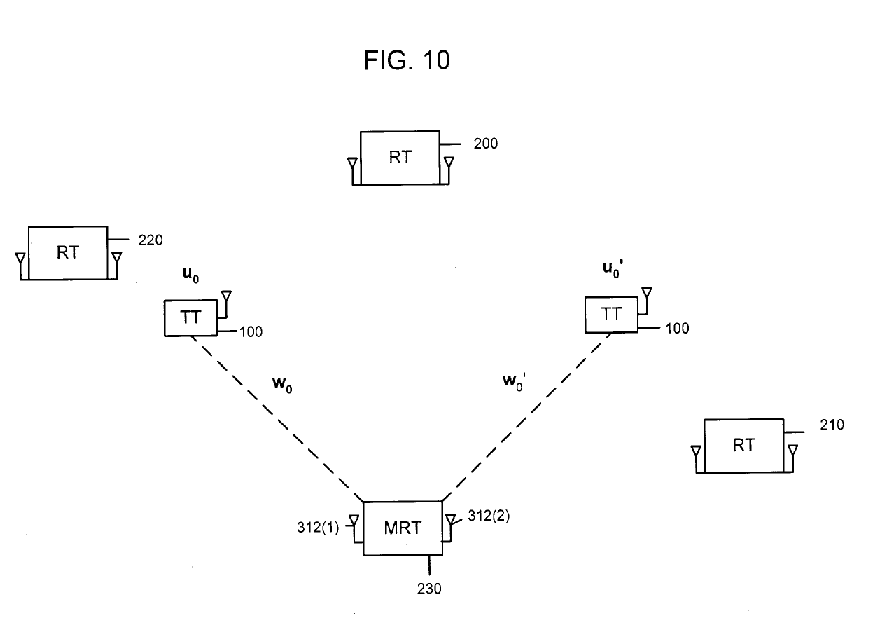

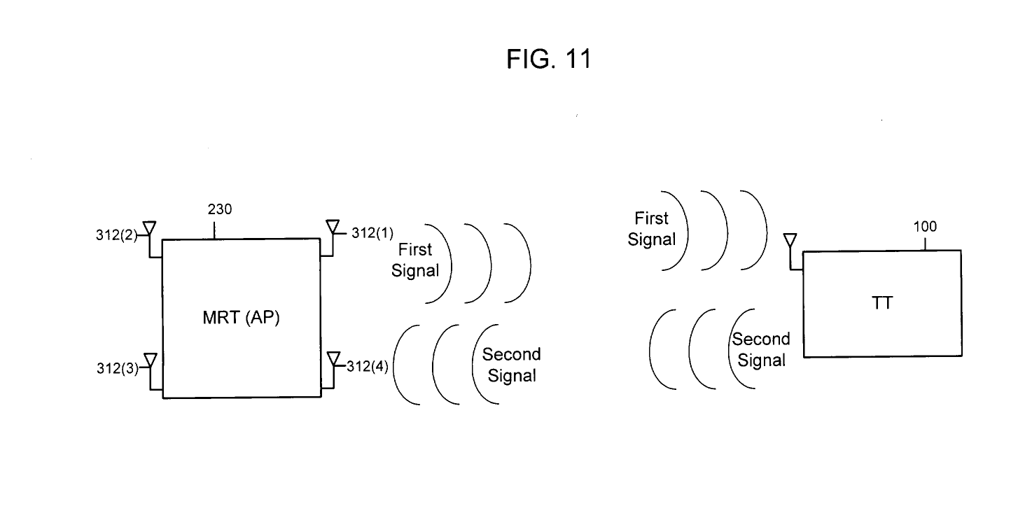

As described hereinafter, there are at least two options to deal with this location ambiguity. First, a TDOA can be taken at an additional known location (e.g., RT). Second, a hypothesis test can be performed to identify the correct location solution. Examples of hypothesis tests are described hereinafter in conjunction with FIG. 10. Table 1: Minimum Number of Known Locations for Locating a TT Given Other Factors

| | | Minimum Number |
|---|---|---|
| | | of Known |
| Know One | | Locations (e.g., |
| Coordinate (e.g., z) | Collaborative TT | RTs) |
| X | X | 2 |
| X | | 3 |
| | X | 3 |
| | | 4 |

Exemplary Collaborative Devices

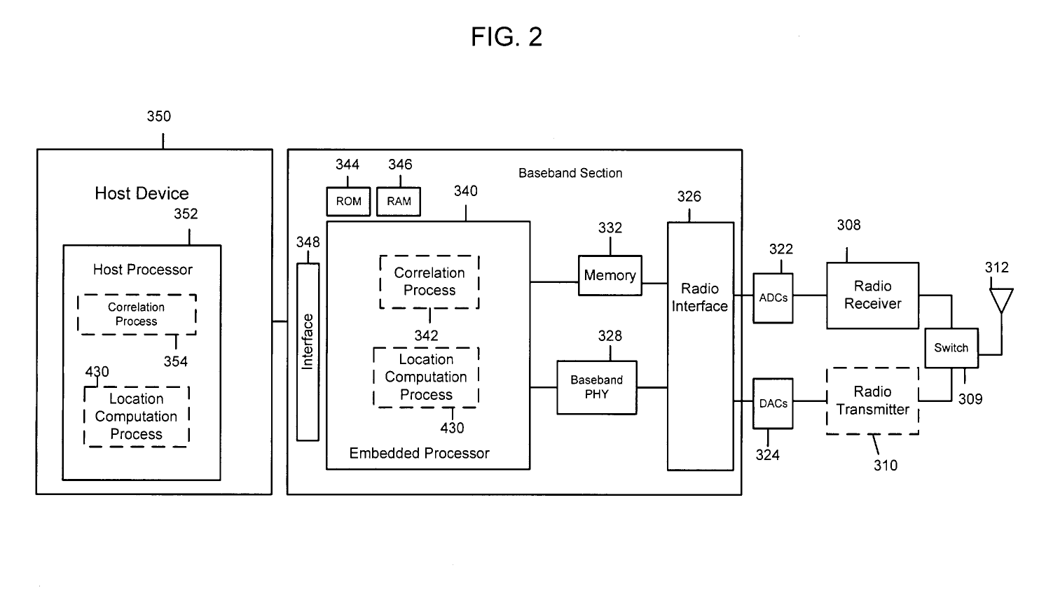

FIG. 2 is a block diagram of an exemplary RT or MRT. Any device that has an analog-to-digital converter (ADC) and access to its digital output, or access to the analog output of the receiver portion of the radio receiver may be made a collaborative device, insofar as the receiver output can be digitized and stored for the time interval(s) of interest.

The terminal includes a radio receiver 308 that receives signals via an antenna 312. An MRT has the ability to transmit and receive and therefore may have a radio transmitter 310 (which may be part of a radio transceiver that integrates the radio receiver and radio transmitter). A switch 309 may couple the radio receiver or radio transmitter 310 to the antenna 312. An RT need not have the ability to transmit, and therefore has at least a radio receiver. There are one or more analog-to-digital converters (ADCs) 322 and digital-to-analog converters (DACs) 324 (for a terminal that also transmits signals). A baseband section 320 (which may be a separate integrated circuit) may be coupled to the ADCs 322 and DACs 324 via an RF interface 326. Baseband signal processing may be performed in a baseband physical block (PHY) 328 in firmware. A memory 332 is provided that is coupled to receive the digital output of the ADC 322 and may be any storage element or buffer memory capable of storing output of the ADC 322. It need not reside in the baseband section 320 proper. The memory 332 should be large enough to store at least a portion of a first signal sent by the MRT and a portion of a second signal sent by the TT, as well as other miscellaneous information in the time interval between the signals. Examples of these signals are described further hereinafter. In the case where the terminal is the MRT 230, the memory 332 will store the digital input samples to the DAC 324 that are used to transmit a first signal (in order to identify a reference time point of the first signal), as well as the digital output samples of the ADC 322 representing a received second signal (in order to identify a reference time point of the second signal).

Higher level processing capability may be provided in an embedded processor 340 that executes, among other functions, a correlation process 342 like the one referred to above that may be performed by the NS. The embedded processor 340 may execute instructions stored in a ROM 344 and/or RAM 346.

The baseband section 320 may be coupled to a host device 350 via a suitable interface 348, such as a universal serial bus (USB), PCI/Cardbus, or event an Ethernet connection/port. The host device 350 has a host processor 352 that may also execute, among other functions, a correlation process 354. The correlation process 354 in the host device 350 is the same as the correlation process 342 in the embedded processor 340 which is the same as the correlation process 420 in the NS 400. It need not be performed in all locations, but only in one of these locations.

A further variation is shown in FIG. 2 in which the RT may have the capability to execute the location computation process 430 in its embedded processor 340 or hosted processor 352 using the TDOA information obtained locally and collected (by wired or wireless link) from other RTs.

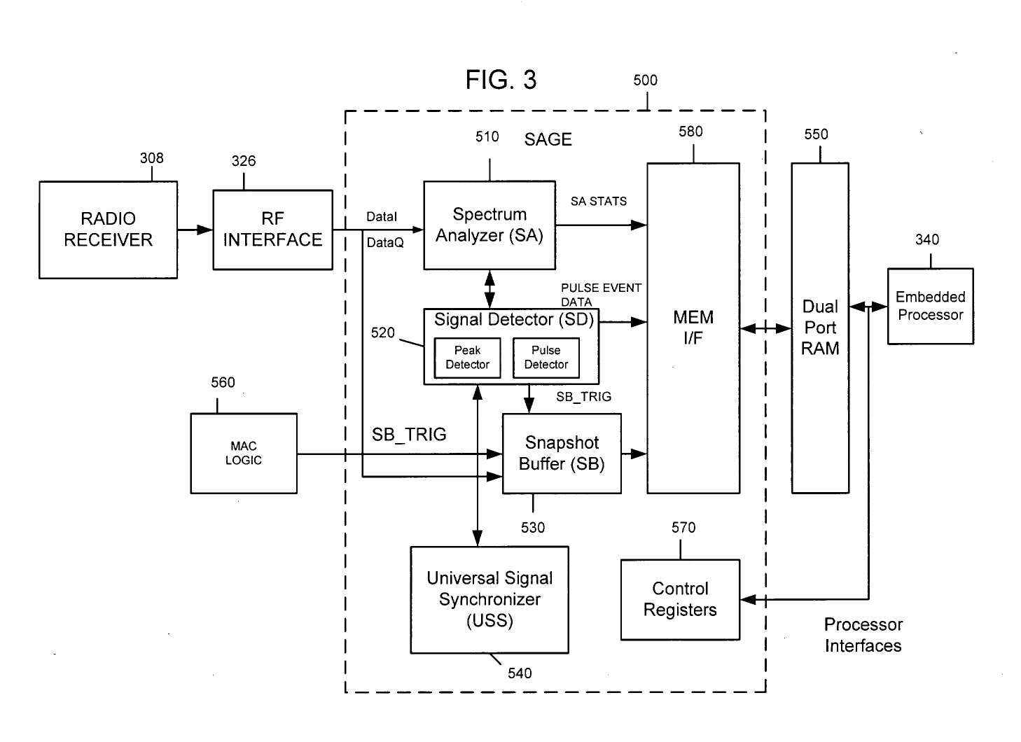

One example of a sub-system which includes a memory that can be included in a terminal to make it collaborative is a real-time spectrum analysis engine (SAGE) 500 shown in FIG. 3. The SAGE 500 comprises a spectrum analyzer 510, a signal detector 520, a snapshot buffer 530 and a universal signal synchronizer 540. The SAGE 500 receives digital data representing the output of an ADC (which may be included in the RF interface 326). The spectrum analyzer 520 generates data representing a real-time spectrogram of a bandwidth of radio frequency (RF) spectrum, such as, for example, up to 100 MHz. The output of the SA 520 may comprise power values for each of a plurality of frequency bins that spans a portion or substantially the entire frequency spectrum of interest.

The signal detector 520 detects signal pulses in the frequency band that satisfy a set of configurable pulse characteristics and outputs pulse event data for those detected pulses. The pulse event data may include one or more of the start time, duration, power, center frequency and bandwidth of each detected pulse. The signal detector 520 also provides pulse trigger outputs which may be used to enable/disable the collection of information by the snapshot buffer 530. The signal detector 520 may include one or more pulse detectors each configured to detect pulses that satisfy a certain set of criteria. The signal detector 520 may comprise a peak detector that detects power level above a certain threshold in a frequency bin of data output by the spectrum analyzer 510, and a pulse detector coupled to the peak detector that detects from the peak information pulses that meet the configured criteria. The pulse event data output by the signal detector may be useful in determining the periodic or aperiodic nature of a signal whose source is to be located, or to classify by type (frequency hopper, cordless telephone, Bluetooth™, IEEE 802.11x, infant monitor, unknown, etc.) of signal to be located. Knowing the type of the signal to be located, or at least its transmit behavior, can be useful in deciding on what type of signaling process to use in order to obtain TDOA measurements to locate the source of the signal.

The snapshot buffer 530 is a memory that stores a set of raw digital receive data which is useful for the reasons described above. The snapshot buffer 530 can be triggered to begin sample collection by either the signal detector 520 or from an external trigger source using the snapshot trigger signal SB_TRIG. Furthermore, the snapshot buffer 530 has two modes of operation: pre-store mode and post-store mode. In a pre-store mode, the snapshot buffer 300 writes continuously to the DPR 550 and stops writing and interrupts the embedded processor 340 when a snapshot trigger signal is detected. In a post-store mode, the DPR write operation begins only after a trigger is detected. A combination pre- and post-store scenario may be created to capture samples of the receive data signals both before and after a snapshot trigger condition.

The universal signal synchronizer 540 synchronizes to periodic signal sources, such as Bluetooth™ SCO headsets and cordless phones. The USS 540 interfaces with medium access control (MAC) logic 560 that manages scheduling of packet transmissions in the frequency band according to a MAC protocol, such as, for example, the IEEE 802.11 protocols. The MAC logic 560 may generate the snapshot trigger signal SB_TRIG upon detecting a particular signal, such as the first signal transmitted by the MRT (e.g., an RTS) based on that the MAC logic 560 processes. This may be a useful feature for the location measurements techniques described herein, but it is not required.

The embedded processor 340 interfaces with the SAGE 500 to receive spectrum information output by the SAGE 500, and to control certain operational parameters of the SAGE 500. The embedded processor 340 interfaces with SAGE 500 through the DPR 550 and the control registers 570. The SAGE 500 interfaces with the embedded processor 340 through a memory interface (I/F) 580 that is coupled to the DPR 550.

To summarize, the SAGE 500 is a sub-system useful in a radio device to perform pulse level analysis of energy detected in a radio frequency band. One feature of the SAGE 500 is to capture raw receive signal data in a memory (e.g., snapshot buffer). The snapshot trigger signal that causes the memory to store data may be supplied by a suitably configured pulse detector forming a part of the signal detector component of the SAGE 500 (that is responsive to a signal pulse representative of the occurrence of the first signal), or from MAC logic that tracks the MAC protocol activity associated with signals communicated between devices in the frequency band and detects occurrence of the first signal. Further details on the SAGE 500 are disclosed in commonly assigned co-pending U.S. application Ser. No. 10/246,365, filed Sep. 18, 2002, entitled “System and Method for Real-Time Spectrum Analysis in a Communication Device,” the entirety of which is incorporated herein by reference.

The Location Measurement Process in More Detail

The location measurement process involves transmitting a first signal, which may be an outbound signal, from a terminal in the general proximity of the TT. The first signal may be transmitted by the MRT at a known location, but may be transmitted also from a terminal whose location is not known. If the TT operates according to a communication standard that employs a particular outbound/reply exchange protocol of the MRT or other terminal that transmits the first signal, then the TT may respond with a second signal, called a reply signal. Two or more RTs (e.g., MRT plus one RT) capture at least part of the outbound-reply signal exchange. TDOA measurements are computed between some reference point of the first signal, e.g., outbound signal and some reference point of the second signal, e.g., reply signal at each of the known locations (e.g., at least two RTs, one of which may be the MRT). This time difference information is used to compute the location of the TT.

The outbound signal and reply signal may follow a carrier sense multiple access-collision avoidance (CSMA-CA) protocol. Under a CSMA-CA protocol, the outbound signal may be an RTS packet addressed to the TT and the reply signal may be a CTS packet sent by the TT. The time between an RTS packet and a subsequent CTS packet is variable, within some specified tolerance. In a WLAN environment, the IEEE 802.11 standard uses a CSMA-CA protocol with these features. One advantage of using the built-in RTS/CTS feature of the IEEE 802.11 standard is that no special ranging messages need to be configured and made recognizable at the terminals. There is no need for any special cooperation from the TT. All devices operating in an 802.11 wireless network are required to respond to an RTS message addressed to it. Moreover, the RTs may receive and store data associated with the RTS/CTS exchange even though they will not respond to the RTS message. The RTS/CTS message exchange is only meant to be an example of the signals that may be used in accordance with the location measurement process described herein. The obvious benefit of using the RTS/CTS message exchange is that these signals are already supported in IEEE 802.11 devices. Moreover, an RT receives and demodulates the RTS and CTS signals using the normal sampling rates of the IEEE 802.11 protocol. No special high precision timing processes are needed.

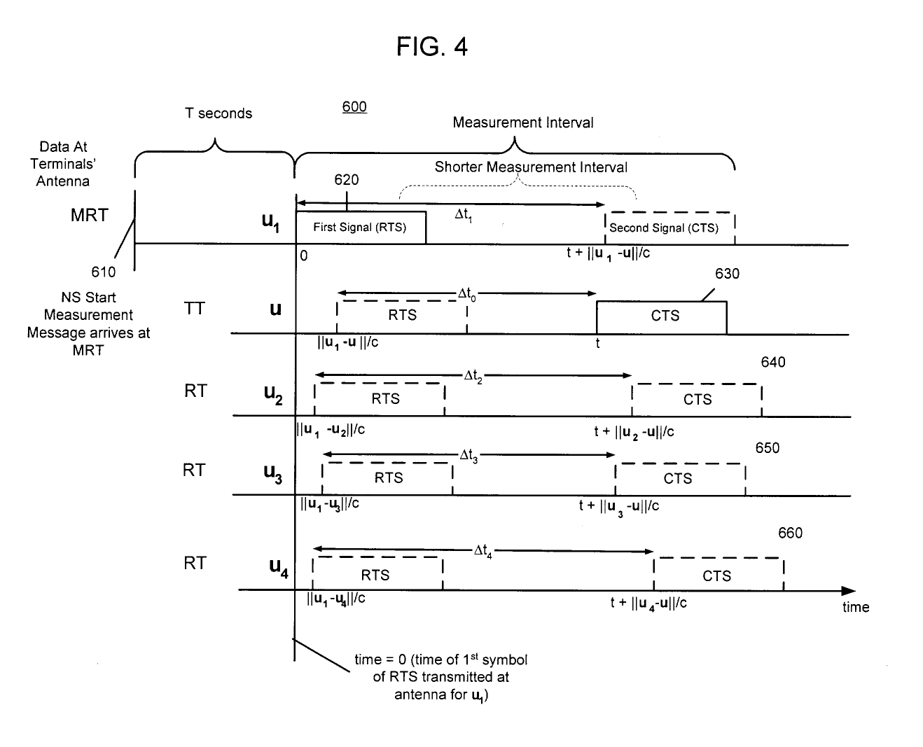

FIG. 4 illustrates a process 600 to obtain measurement data pertaining to the location of a TT in an environment such as that shown in FIG. 1. To facilitate understanding of FIG. 4, signals that are transmitted by a device are indicated in solid lines and signals that are received by a device are indicated in dotted lines. As many as four locations u₁-u₄ may be known at the NS, such as for the MRT and the other RTs. Initially, the NS identifies the appropriate RTs for the measurement process, and in step 610, sends a “start measurement” message to the MRT and RTs directing them to capture ADC receive signal data beginning at time T seconds from the arrival time of the NS message (T can be approximately 100 ms). It should be understood that if the terminal from where the first signal is transmitted is at an unknown location, then the “start measurement” message would be sent to that terminal and the other RTs used in the measurement process.

Instead of starting the memory to capture at a fixed time after the NS “start measurement” message, the pre-store/post-store features of the snapshot buffer 530 may be used in the RTs (thereby making it a variable trigger and reducing memory allocation requirements for the memory) as described above in conjunction with FIG. 3. The MAC logic detects the first signal (e.g., RTS), and in response issues a SB_TRIG signal that is coupled to the buffer to start post-storing samples.

Still another alternative is for the MRT, or other terminal that will send the first signal, to coordinate the measurement, instead of the NS, by sending the “start measurement” message to the RTs to prepare for the measurement. One advantage the “start measurement” technique is that if an RT or TT is relatively far from the MRT, the remote RT or TT will experience decreased signal-to-noise performance in correlating to the first signal. Therefore, if the RTs know in advance of an impending measurement, their memories can be activated before the first signal/second signal exchange, allowing sufficient capture of the data.

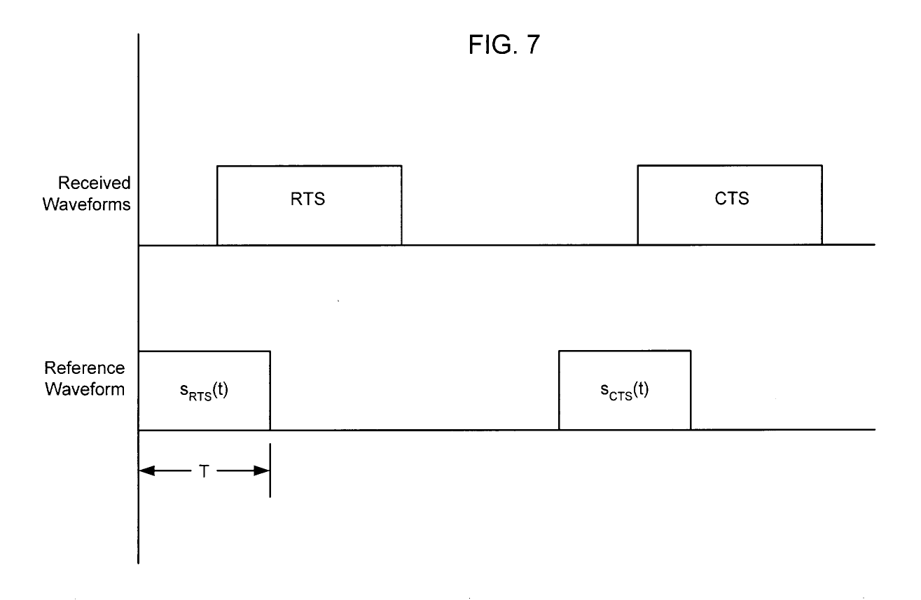

As described hereinafter in conjunction with FIG. 7, appropriate noise average techniques can be used to process these weaker signals to determine the time of arrival measurements. One such technique is to use a correlator length for the first and second signals (e.g., RTS and CTS) that is sufficiently long with respect to the RTS and CTS packets, respectively, so that weaker signals can still be accurately processed.

In the following example, the first signal is an RTS packet/message and the second signal is a CTS packet/message. But, as explained above, it is not required that the first signal be an RTS packet and the second signal be a CTS packet.

T seconds after the arrival time of the NS “start measurement” message at the MRT or other terminal that sends the first signal (advising the MRT and RTs of the impending measurement process), in step 620, the MRT sends an RTS to the TT. The MRT needs to note when the RTS was sent. One way to do this is to capture for storage in the memory the digital data representing the RTS packet that is supplied to the DAC input (FIG. 2) and when it was coupled to the DAC. Calibration for the delay from the input of the DAC to transmission from the antenna would be computed and many techniques to do this are known in the art, and therefore not described herein.

In step 630, the TT responds to the RTS by sending a CTS packet to the MRT. As shown at reference numerals 640, 650 and 660, the MRT and RTs receive and store receive signal data associated with the RTS/CTS exchange in their memories to enable determination of some reference point of the RTS and a reference point of the responsive CTS.

FIG. 4 shows that the complete measurement interval extends from the beginning of an RTS packet to the beginning of the subsequent CTS packet. In some cases, for an IEEE 802.11a network, this would be any where from 64 to 666 μsec. However, the measurement interval need not be this long. As shown in FIG. 4, a shorter measurement interval may extend from just before the end of the RTS packet to just beyond the beginning of the subsequent CTS packet. Using this shorter measurement interval approach, the Δt that is measured is from a reference point (e.g., the end) of the RTS packet to a reference point (e.g., the beginning) of the CTS packet at the MRT and each RT. The advantage of this measurement interval is that less data storage in the memory is required, which, among other things, reduces the memory allocation requirements.

FIGS. 5 and 6 show how to locate a TT 100 that does not operate with the same communication standard as the MRT 230 or other terminal that sends the first signal. For example, if the MRT 230 uses the IEEE 802.11 communication protocol, the TT 100 may be any non-802.11 device. The TT 100 may be a device that transmits periodically or aperiodically. The approximate transmit behavior (periodic or aperiodic) of the TT 100 is determined by listening at an RT to the TT's transmissions over time. For example, the TT 100 may be a cordless phone, Bluetooth™ device, etc. that transmits periodically. Some cordless phones transmit periodically approximately every 10 ms. FIG. 5 shows the transmission behavior of a TT that transmits periodically, and FIG. 6 shows the transmission behavior of a TT that transmits aperiodically.

Techniques to detect a periodic signal are disclosed in the aforementioned co-pending application related to a spectrum analysis engine. In addition, techniques for classifying a signal based on detected signal pulses are disclosed in co-pending and commonly assigned U.S. application Ser. No. 10/246,364 filed Sep. 18, 2002, entitled “System and Method for Signal Classification of Signals in a Frequency Band,” the entirety of which is incorporated herein by reference. Other techniques are known in the art to ascertain the transmission behavior of a device. When the transmit behavior of the TT (through signal classification or other techniques) can be determined, then the signaling technique used to locate that TT can be adjusted accordingly. In addition, determining the transmit behavior of the TT may be used to classify the type of TT signal so that an appropriate correlator may be used to correlate to the TT's signal to compute the TDOA measurements. The RTs, MRT and/or NS may the ability to classify the TT's signal, and select the appropriate one of several correlators to correlate to the TT's signal.

For example, if it is determined that the TT has periodic transmission behavior and its transmit timing is determined, the first signal may be sent immediately before or after the TT's transmission, allowing the RTs to capture in their memories both the first signal and the second signal transmitted by the TT 100. Because the TT is periodic, the NS or MRT 230 (or other terminal) knows when to alert the RTs of an impending measurement cycle. FIG. 5 shows that the first signal is transmitted just before the TT's transmission so that the measurement interval may extend from just before the MRT transmission to just after the TT transmission. The TDOA information with respect to the MRT's first signal and the TT's second signal at two or more known locations is obtained in a manner similar to that described above and using the appropriate correlator for the TT. The computations referred to above in connection with FIG. 4 (and described in more detail hereinafter) may then be performed in a similar manner to determine the location of the TT 100.

With reference to FIG. 6, if the TT 100 is determined to have an aperiodic transmission behavior, the first signal may be a periodic signal, such as any sync signal or pulse used by many communication standards that all RTs will receive as well as the TT's signal. For example, the IEEE 802.11 standard employs a Beacon interval to alert unassociated devices about the existence of a network. Even though the TT's transmission time may not be predictable, there will inevitably be a time interval where the periodic first signal will precede or follow the TT's transmission, sufficient to allow the RTs to obtain TDOA measurements. Also, using a periodic first signal allows the NS or MRT (or other terminal) to predict when a measurement interval will occur in order to alert the RTs of it so they know when to begin capturing data. On the other hand, if the terminal sending the first signal has the ability to communicate with the TT using the TT's communication protocol, then the terminal (e.g., MRT 230) can, for example, transmit a packet that the TT responds to with an ACK packet, and this exchange can be used to capture TDOA measurements at the RTs.

FIG. 7 pictorially shows the correlation process that is performed on the captured data. The waveform correlation process runs in the embedded processor, host processor or NS to correlate to the first signal and second signal, to be able to compute the time difference between a reference point of the first signal (e.g., RTS) and a reference point of the second signal (e.g., CTS). The TDOA measurements are performed by cross-correlating a received waveform with a reference waveform S_{RTS}(t) for the RTS packet and a reference waveform S_{CTS}(t) that is long enough to obtain sufficient SNR to capture part or all of the RTS or CTS, respectively, and time of arrival of a reference point with desirable accuracy. Once the time of arrival measurements are determined, then the TDOA computations are made. Desirable noise averaging is achieved because the long correlator reference waveform enhances the measurement SNR, but does not increase the silicon area/device cost since the correlator is implemented in software. Again, it is possible that the correlator need only correlate to a portion of the RTS and CTS, such as an end portion of the RTS and a beginning portion of the CTS to identify and mark a reference point in each packet (e.g., end of RTS and beginning of CTS) with respect to which a time difference is measured.

In the event that the correlation process is performed at the NS, the RTs may send their captured receive signal data to the NS (either by wired or wireless link). If the RTs perform the correlation process locally, they send (either by wired or wireless link) the computed values as {Δtᵢ} to the NS.

If the first signal is sent by a terminal at a known location, such as the MRT, then the MRT uses a similar technique and reports Δt₁ to the NS (or sends the captured receive signal data necessary for the NS to compute Δt₁). Δt₁ is the difference in arrival time between the CTS the MRT receives from the TT and the RTS that the MRT transmitted from one of its antennas.

Using Δtᵢ, i=1, . . . , 4, and the known location of the RTs (and optionally the MRT), the NS computes the location of the TT by solving the following equation for u and t:
∥uᵢ−u∥−∥uᵢ−u₁∥+c(t−Δtᵢ)=0, i=1, . . . , 4 (1)
where c is the speed of light, and t is the time of the transmission by the TT. This same process can be performed if the TT is responsive to an outgoing ranging message from the MRT, or is another type of device that periodically or aperiodically transmits a signal.

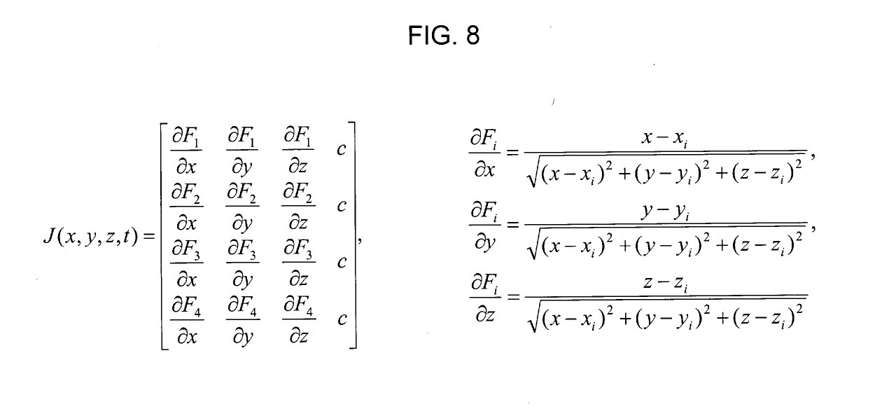

There are many approaches known in the art for solving equation (1). Turning to FIG. 8, one approach involves finding the zero p* of a multi-dimensional, non-linear function F(p) of 4 variables p=[x, y, z, t]. For ranging measurements, one approach is to linearize F(p) about pₖ as follows:
F(pₖ+p)<<F(pₖ)+J(pₖ)p,
where J(pₖ) is the Jacobian of F evaluated at pₖ, and then to use a Newton iteration to solve F(p)=0:
pₖ₊₁=pₖ−J(pₖ)⁻¹F(pₖ) (2)
The Jacobian of F for equation (1) is shown in FIG. 8. A single location solution is produced using this iterative approach.

To produce a measurement accuracy of im or better, a total system timing error of at most 3 ns is desirable. The NS may take into account geometrical dilution of precision (GDOP) due to ill-conditioned Jacobian matrices. The standard deviation of the range estimate due to GDOP can be shown to be s=1/sqrt(trace(J^{T}J)). If the NS determines that the range variance is too large, it may repeat the experiment using a different set of RTs to improve the precision. It should be noted that the entire RTS and CTS packets need not be processed, so long as enough of the packets are processed in order to achieve the desired SNR.

Another approach to solving equation (1) is a closed-form approach which produces two candidate solutions for the location of the TT. Many closed form approaches are known in the art. An example of a closed-form approach is described in the paper Processing of Pseudorange Measurements: An Exact and Iterative Algorithm for the GPS Single Point Positioning, N. Crocetto et al., Proceedings of the Workshop International Cooperation and Technology Transfer—ISPRS Commission VI, Working Group 3, Perugia, 16-20 Feb. 1998, pp. 134-141, the entirety of which is incorporated herein by reference. Techniques for selecting one of the two candidate locations produced by a closed-form approach are described hereinafter in conjunction with FIG. 10.

The accuracy of the measurements may be improved by determining the frequency error of the MRT clock. One way to improve the frequency error is for the NS to send to the MRT start count and stop count signals separated by a fixed time period for several iterations to determine the frequency error in PPM of the MRT clock. All of the time measurements (at the RTs) are made relative to the MRT clock whose frequency error is known. Other techniques to determine the frequency error of the MRT clock may also be known in the art.

The basic location measurement principles described above can be adapted for conditions under which TDOA measurements need to be made at only 3 or as few as 2 known locations. When one coordinate of the TT is known (e.g., a vertical position for same-floor measurements), TDOA measurements at only 3 known locations are required to solve equations (1) & (2) since the z-coordinate of the position vector u is known.

Furthermore, when the TT is a collaborative device and a 3-D position measurement is desired, TDOA measurements at only 3 known locations are needed. A collaborative TT can capture received signal data to enable a TDOA measurement, e.g., Δt₀=t−∥u−u₁∥/c, and that TDOA measurement can be included in the computation of equation (1), where Δt₀ is the TDOA measurement derived from the data captured at the TT (assuming in this example that the MRT sends the first signal). This provides one additional equation to the system of equations.

There are also conditions under which TDOA measurements at only 2 known locations are required to make a location measurement. This is the case, for example, when one coordinate of the TT is known (e.g., its vertical position z) and the TT is a collaborative device (assuming again in this example that the MRT sends the first signal). Again, Table 1 above lists the various measurement possibilities depending on what information is available.

Resolving Location Ambiguity

There are actually 2 solutions to equation (1) for u since the solution to the system of equations consists of the intersection of two circles or three spheres.

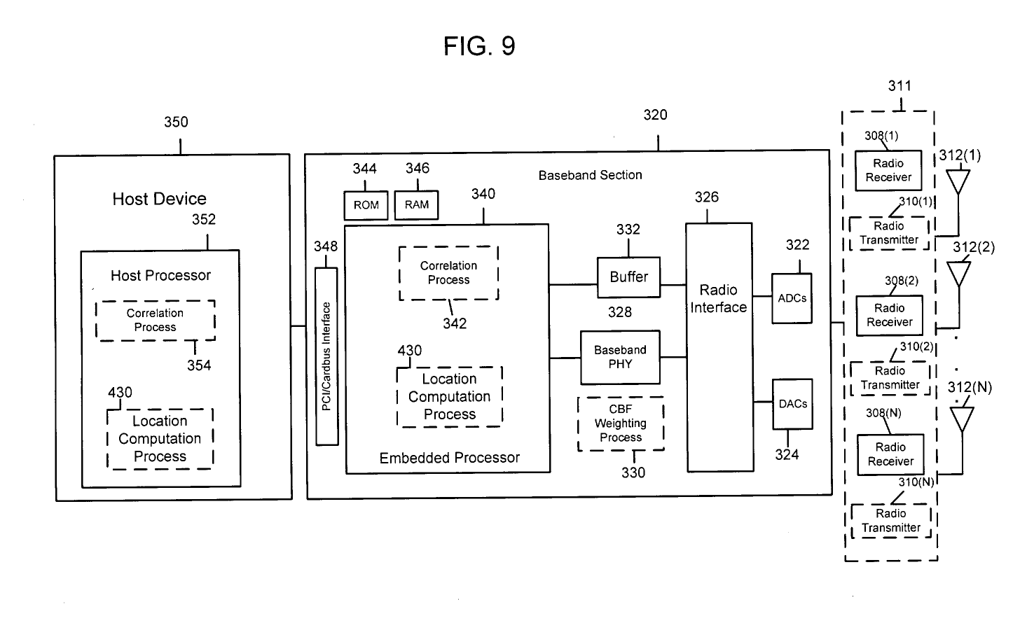

FIG. 9 illustrates a block diagram of a terminal (MRT, RT and/or TT) useful in variations to the process shown in FIG. 4 and for performing a hypothesis test to resolve location ambiguity in solving equation (1). The block diagram of FIG. 9 is similar to that of FIG. 2, except that the terminal has multiple (e.g., 2 or more) antennas 312(1), 312(2) through 312(N) and multiple (e.g., 2 or more) radio receivers 308(1), 308(2) through 308(N) each of which can process a signal for a corresponding one of the antennas. If the RT is also an MRT or TT, it may include multiple radio transmitters 310(1), 310(2) to 310(N) associated with a corresponding antenna. One way to deploy multiple radio receivers and multiple radio transmitters is in a multiple-input multiple-output (MIMO) radio transceiver shown at reference numeral 311. In addition, there is an optional composite beamforming (CBF) process 330 in the baseband IC 320 that is used to generate and apply transmit weights to signals to be transmitted and receive weights to received signals. The CBF process is described in more detail in commonly assigned and co-pending U.S. application Ser. No. 10/174,728, filed Jun. 19, 2002, entitled “System and Method for Antenna Diversity Using Joint Maximal Ratio Combining”; U.S. application Ser. No. 10/174,689, filed Jun. 19, 2002, entitled “System and Method for Antenna Diversity Using Equal Gain Joint Maximal Ratio Combining”; U.S. application Ser. No. 10/064,482, filed Jul. 18, 2002, entitled “System and Method for Joint Maximal Ratio Combining Using Time Domain Signal Processing”, the entirety of all of which are incorporated herein by reference. Briefly, the CBF process computes and applies transmit weights against component signals (of one or more transmit signal(s)) that are sent simultaneously via individual antennas to another device. Likewise, the CBF process computes and applies receive weights against component signals (of one or more receive signals(s)) that are received via individual antennas from another device. An example of a MIMO radio transceiver is disclosed in commonly assigned co-pending U.S. application Ser. No. 10/065,388, filed Oct. 11, 2002, and entitled “Multiple-Input Multiple-Output Radio Transceiver”, the entirety of which is incorporated herein by reference. If each of the MRT, RT and TT are beamforming-capable, then the measurement process shown in FIG. 4 may be repeated multiple times using different transmit weights at the MRT (when transmitting the RTS) and TT (when transmitting the CTS) to mitigate the effects of multi-path. Moreover, a device having multiple antennas and multiple receivers can compute the relative amplitude and phase of a signal (e.g., the first signal and the second signal) received by each of the antennas.

There are known closed-form solutions to equation (1) that produce two candidate positions, referred to as positions u₀ and u₀′, of the TT. With reference to FIG. 10, a hypothesis test is described to select the proper one of the two solutions to equation (1) using an MRT 230 with multiple antennas (such as two antennas) 312(1) and 312(2). The MRT 230 generates two transmit antenna vectors w₀ and w₀′ associated with its antennas, vector w₀ to point a beam to position u₀ and vector w₀′ to point a beam to position u₀′. The MRT 230 then selects the position that produces the highest received signal strength as seen through the corresponding antenna beam. Specifically, if the location of the MRT is u₁, then the MRT computes the quantity |<u₁, w₀>|/[∥u₁∥∥w₀∥] and the quantity ∥<u₁, w₀′>|/[∥u₁∥∥w₀′∥]. If the quantity for w₀ is greater, then u₀ is the solution, otherwise, u₀′ is solution. Techniques to generate weights that direct a beam from a multiple antenna (or antenna array) device to a particular location are well known in the art, and are therefore not described herein. For some situations (e.g., when the location is perpendicular to the MRT's antennas), this angle of arrival technique may not work, but there are several other techniques known in the art (and thus not described herein) that can be used to resolve the proper location from the two solutions.

Another technique for selecting the correct one of the candidate positions u₀ or u₀′ is described, again with reference to FIGS. 9 and 10. According to this technique, the position of the TT is modeled to be a random vector U that can take on either position u₀ or u₀′ with equal probability. Some basic definitions and assumptions follow. There are N RTs, individually denoted RTᵢ for i=1 to N. Each RT has a plurality of antennas to at least receive signals, and specifically the capability to store data associated with the signal transmitted by the TT (referred to as the “second signal” above) and received at each of its plurality of antennas. The channel response between the plurality of antennas of the RTᵢ and the TT depends on the position U of the TT. H=Γ(U,uᵢ) is the candidate channel response vector between RTᵢ and the TT at position U and is a function Γ of U and uᵢ. Since U is random, H is a discrete random vector that is either Γ(u₀, uᵢ) or r(u₀, uᵢ). The distances between the TT antenna(s) at each candidate position u₀ and u₀′ and each antenna of RTᵢ is known because, by definition, the position of the RT (and specifically each of the RTᵢ's antennas) are known. Assuming a line-of-sight (LOS) channel between the TT and RTᵢ, the candidate channel response vectors r(u₀, uᵢ), r(u₀′, uᵢ) for RTᵢ can be computed using this information for the candidate positions u₀ and u₀′ of the TT. For non-LOS environments, the LOS channel is used as an estimate. G=H+N=Γ(U,uᵢ)+N, is the channel response (perturbed by estimated noise, assumed to be Gaussian) observed at RTᵢ between the TT and RTᵢ and is a discrete random vector that is a function of the position of the TT and the position of RTᵢ. The observed channel response vector gᵢ for RTᵢ can be determined from the (measured amplitude and phase of the) received second signal from the TT at each antenna j of RTᵢ, where j=1 to M. Each RT need not have the same number (M) of antennas.

Assuming the positions u₀ and u₀′ have or can be computed using the TDOA information described above, the NS gathers data for the observed channel response vectors at the RTs: g₁=G(U, u₁), . . . , g_{N}=G(U, u_{N}) from the data collection process described above in conjunction with FIG. 4. In addition, the NS computes the two candidate channel response vectors Γ(u₀, uᵢ), Γ(u₀′, uᵢ) for each RTᵢ.

The NS selects as the TT position the position u that maximizes the conditional probability:

$$Pr ( U = u \vert {G}_{1} = {g}_{1} , … , {G}_{N} = {g}_{N} ) = \frac{{f}_{G \vert U} ( {g}_{1} , … , {g}_{N} \vert u ) Pr ( U = u )}{{f}_{G} ( {g}_{1} , … , {g}_{N} )}$$

over u={u₀, u₀′}. The denominator can be ignored because it does not depend on the selection of u₀ or u₀′. The Pr(U=u) factor in the numerator can be ignored because it is a constant 0.5. Therefore, maximizing the above expression over u is equivalent to maximizing:

$$\begin{matrix}{f}_{G \vert U} ( {g}_{1} , … , {g}_{N} \vert u ) = {f}_{N \vert U} ( {g}_{1} - {h}_{1} , … , {g}_{N} - {h}_{N} \vert u ) \\ = {f}_{N} ( {g}_{1} - {h}_{1} , … , {g}_{N} - {h}_{N} ) \\ = K \cdot {ⅇ}^{- ( \frac{{‖ {g}_{1} - {h}_{1} ‖}^{2}}{2 {δ}^{2}} + … + \frac{{‖ {g}_{N} - {h}_{N} ‖}^{2}}{2 {δ}^{2}} )}\end{matrix}$$

This last equation follows because the noise N is assumed to be jointly Gaussian. Therefore, using this equation, maximizing the above probability over {u₀, u₀′} is equivalent to selecting u₀ or u₀′ that minimizes the sum-of-squared Euclidean distances between the observed channel response vector gᵢ and the candidate channel response vectors hᵢ, i.e., minimizes Σ∥hᵢ−gᵢ∥²/2σ², for i=1 to N. For some applications, the NS may choose to use angle-of-arrival information only, discarding the distance information carried by g and h. In this case, the NS may normalize vectors gᵢ and hᵢ such that ∥h_{i,j}∥=∥g_{i,j}∥=1, for i=1 to N, and j=1 to M, and thus ignore the amplitude relationship in gᵢ and hᵢ and use only the phase relationship (for angle-of-arrival only). When the vectors gᵢ and hᵢ are not normalized, the RTs that are closer to the actual position of the TT contribute more to the sum than without normalization.

Again with reference to FIGS. 9 and 10, still another technique to resolve location ambiguity is based on angle-of-arrival (e.g., phase) information obtained at each of the RTs involved in the location measurement. For example, if an RT has multiple antennas, the RT can generate relative phase information at each antenna when receiving the second signal from the TT at each antenna. Using the phase information at each RT, a confidence score can be assigned to the two candidate locations u₀ or u₀′ for the perspective of that RT. The confidence score may be a “soft” decision that varies between two values (e.g., −1, to 1) or a hard decision (e.g., 0 or 1). The confidence scores for all RTs are summed to produce a total score to select one of the two candidate positions as the actual position of the TT.

There is another variation when the MRT or TT has multiple antennas, similar to the block diagram shown in FIG. 9. In order for the MRT to measure the transmit time of the first signal (if the MRT is the terminal that transmits the first signal), the MRT may use one antenna path to transmit the first signal, and use another path to simultaneously receive the first signal and store the ADC samples of the first signal it in its memory. Similarly, the TT may use one antenna path to transmit the second signal, and use another path to simultaneously receive the second signal, and store the ADC samples of it in its memory. Alternatively, the TT may store in its memory the digital input to its DAC that are used to transmit the second signal.

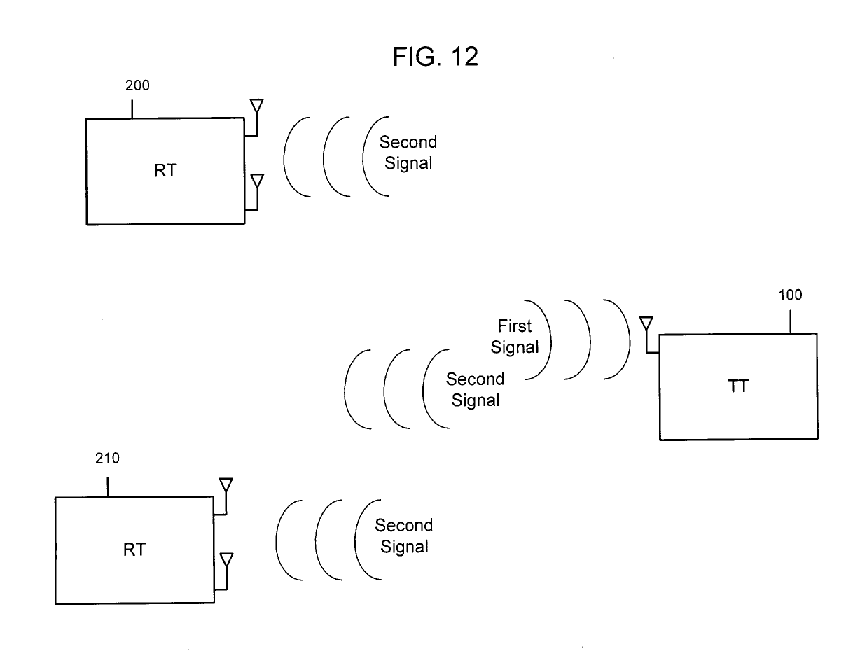

FIGS. 11 and 12 illustrate other ways to obtain reference time difference of arrival measurements in order to perform the location computations described above in conjunction with FIG. 4. Again, reference is made to Table 1 above. In FIG. 11, an RT, such as the MRT 230, has at least four antennas 312(1), 312(2), 312(3) and 312(4) and multiple radio receivers, giving it the ability to detect the second signal (e.g., CTS packet) separately at each antenna, as described above in conjunction with FIG. 9. The time of arrival measurements at each of the antennas of the MRT may be used to perform the measurement computations. Under these conditions, no other RT is needed for the measurement process. In FIG. 12, there are one or two RTs 200 and 210 each having two antennas. The TDOA measurements at each of the two antennas of each RT (for a total of up to four measurements) can be obtained and used for the location computations.

In FIGS. 11 and 12, as explained in Table 1, if one coordinate (e.g., the vertical position (z)) of the TT is known and the TT is a collaborative device, then the measurements at each of two antennas of an RT can be obtained and used to compute the remaining two coordinates (e.g., x and y). Consequently, TDOA measurements can be obtained all at a single device. Moreover, the MRT 230 may also transmit the first signal used in the measurement process using one of its two or more antennas, and it can receive the first signal at each of its other two or more antennas where the second signal from the TT will also be received. Thus, the entire location measurement process can be initiated from a single device. Further still, that single device, e.g., MRT 230, may have capability to execute both the correlation process and the location computation process locally such that the TDOA measurements can be obtained and the location of the TT computed at a single device. Alternatively, a multiple antenna RT (e.g., MRT) can send captured receive signal data or the TDOA data to the NS where the necessary computations are made.

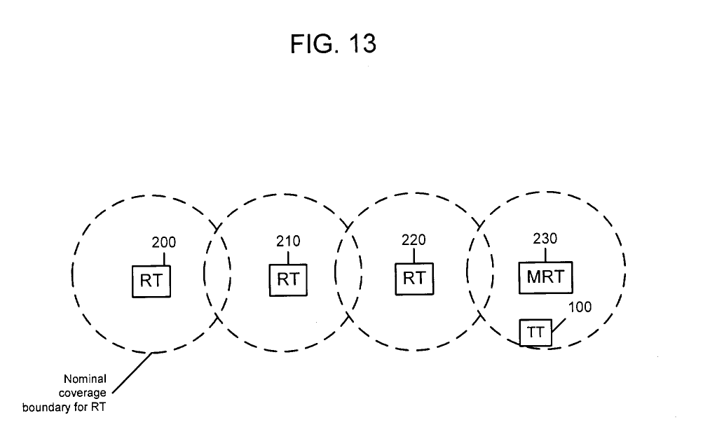

With reference to FIG. 13, a process is described for locating a terminal outside the normal coverage range. It is reasonable to expect that on occasion the TT 100 will be outside the coverage range of at least one of the RTs or an RT will be too far from an MRT 230 to strongly detect a first signal, e.g., an RTS, from the MRT 230. The correlation-based detector used in the MRT 230 and RTs 200, 210 and 220 is optimized to increase the probability of detection of the RTS and CTS packets under low SNR conditions. FIG. 13 shows that the worst-case distance between the TT 100 and a RT is approximately six times the distance between the TT 100 and the MRT 230. In an indoor environment, a 6-times distance penalty corresponds to approximately a 25 dB SNR penalty. Therefore, the correlator packet lengths for the RTS and CTS packets are made long enough to supply sufficient noise averaging to make up for the SNR degradation at the output of the correlator.

Using a 20 MHz noise bandwidth, a correlator packet length of 10\hat{ }(0.1*25)/20 MHz=15.8 μs is required to provide 25 dB SNR enhancement. The shortest packet length for an RTS is 24 μs for an IEEE 802.11a link at 54 Mbps and 52 μs for an 802.11a link at 6 Mbps, which, using a 20 MHz noise bandwidth for OFDM, supplies an SNR increase of 10*log(6400/50)=25.6 dB at the output of the correlator.

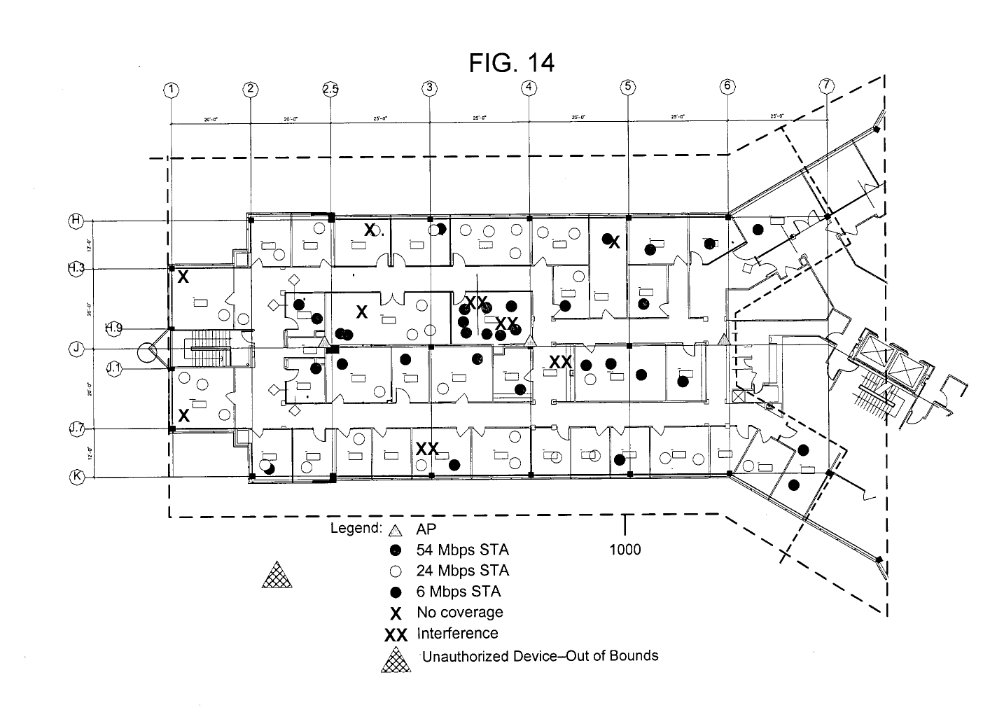

FIG. 14 shows an example of a coverage map that can be generated using the location measurement techniques described herein. The coverage map integrates the locations of multiple devices into a visual display of an area, such as an office space. The coverage map may show the locations of APs and STAs as well as areas of no coverage and areas of interference.

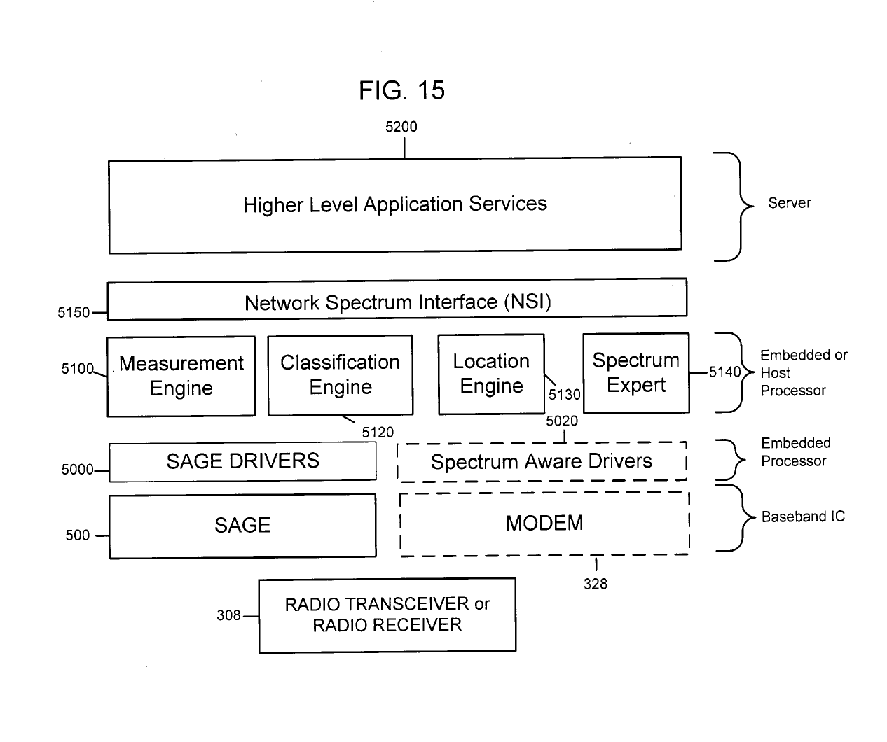

FIG. 15 is diagram illustrating how the location processes described above may be used as a part of a spectrum management system for an unlicensed band. The SAGE 500 in cooperation with the radio 308 generates spectrum activity information that is used by one or more software programs. SAGE drivers 5000 are used by the one or more software applications to configure and access information from the SAGE 500. Examples of software the software programs that may use information from the SAGE 10 including a measurement engine 5100, a classification engine 5120, a location engine 5130 (which executes the location processes described herein) and a spectrum expert 5140. At still a higher level above these software programs may be higher level application services 5200, such as user interface applications, network management applications, etc. A network spectrum interface (NSI) 5150 serves as an application programming interface 10 between the higher level application services 5200 and the processes on the other side of the NSI 5150.

The measurement engine 5100 collects and aggregates output from the SAGE 500 and normalizes the data into meaningful data units for further processing. Specifically, the measurement engine 5100 accumulates statistics for time intervals of output data from the SAGE 500 to track, with respect to each of a plurality of frequency bins that span the frequency band, average power, maximum power and duty cycle. In addition, the measurement engine 5100 accumulates pulse events for signal pulses output by the SAGE 500 that fit the configured criteria. Each pulse event may include data for power level, center frequency, bandwidth, start time, duration and termination time. The measurement engine 5100 may build histograms of signal pulse data that is useful for signal classification. Finally, the measurement engine 5100 accumulates raw received signal data (from the snapshot buffer of the SAGE 500) useful for location measurement (as described above) in response to commands from higher levels in the architecture. The measurement engine 5100 may maintain short-term storage of spectrum activity information. Furthermore, the measurement engine 5100 may aggregate statistics related to performance of a wireless network operating in the radio frequency band, such as an IEEE 802.11 WLAN. In response to requests from other software programs or systems (via the network spectrum interface described hereinafter), the measurement engine 5100 responds with one or more of several types of data generated by processing the data output by the SAGE 500.

The classification engine 5120 compares the outputs of the SAGE 10 against data templates and related information of known signals in order to classify signals in the frequency based on energy pulse information detected by the SAGE. One technique that the classification engine 5120 may use is to examine pulse timing signatures associated with accumulated signal pulse events, detected by the SAGE signal detector, and compare those pulse timing signatures against a database of pulse timing signatures for known signals. Still another technique is to build pulse histograms for pulse center frequency, pulse bandwidth, time between pulses, etc., from the accumulated signal pulse event data, and compare the pulse histograms against pulse histograms for known signals. The measurement engine 5100 may build the histograms. The classification engine 5120 can detect, for example, signals that interfere with the operation of one or more devices (e.g., occupy or occur in the same channel of the unlicensed band as a device operating in the band). The output of the classification engine 5120 includes classifiers of signals detected in the frequency band. A classification output may be, for example, “cordless phone”, “frequency hopper device”, “frequency hopper cordless phone”, “microwave oven”, “802.11x WLAN device”, “Bluetooth™ SCO or ACL signal” etc. The classification engine 5120 may compare signal data supplied to it by the measurement engine against a database of information of known signals or signal types. The signal classification database may be updated for new devices that use the frequency band. An example of a classification engine is described in the aforementioned co-pending application.

The classification engine 5120 may be useful in conjunction with the location process as described to select a signal correlation scheme to be used at the MRT, RT and/or NS based on the type of signal the TT transmits. For example, the classification engine 5120 stores data for known signal types and compares the output of the SAGE 500 and/or measurement engine 5100 against that data to classify the TT's signal. Furthermore, the signal correlation information for each of the known signals may be stored so that after the signal is classified, the appropriate signal correlator information can be used to identify a reference point in the TT's transmission from the captured data at each of the RTs (known locations) to make the TDOA measurements from the first signal/second signal captured data.

The location engine 5130 may execute one of the location processes described herein. The output of the location engine 5130 may include position information, power level, device type (if classification is also used) and/or device (MAC) address. A network security application below or above the NSI may command the location engine 5130 to locate a rogue device that may present a possible security problem.

The spectrum expert 5140 is a process that optimizes operation of devices operating in the frequency band, given knowledge about the activity in the frequency band obtained by the measurement and classification engines. For example, the spectrum expert 5140 processes data from the SAGE 500 and optionally statistics from a particular wireless network operating in the frequency band, such as an IEEE 802.11x network, in order to make recommendations to adjust parameters of a device, or to automatically perform those adjustments in a device. The spectrum expert 5140 may be a software program that is executed, for example, by a network management station. Parameters that can be adjusted (manually or automatically) based on output of the spectrum expert 5140 include frequency channel, transmit power, fragmentation threshold, RTS/CTS, transmit data rate, CCA threshold, interference avoidance, etc. Example of interference mitigation techniques are described in commonly assigned and co-pending U.S. application Ser. No. 10/248,434, filed Jan. 20, 2003, and entitled “Systems and Methods for Interference Mitigation with Respect to Periodic Interferers in Short-Range Wireless Applications,” the entirety of which is incorporated herein by reference. The spectrum expert 5140 may operate on triggers for alert conditions in the frequency band, such as detection of a signal that interferes with the operation of a device or network of devices operating in the frequency band, to automatically report an alert, and/or adjust a parameter in a device in response thereto. For example, the spectrum expert 5140 may operate to control or suggest controls for a single WLAN AP.

The NSI 5150 may be transport independent (e.g., supports Sockets, SNMP, RMON, etc.) and parses spectrum information into sub-sections for session and radio control, measurement, events (classification), location and protocol specific enhanced statistics and controls. End user on-demand commands to check the spectrum knowledge or activity information at a particular device may be received from an application residing above the NSI 5150 and translated into a request for a particular process below the NSI 5150 to supply the requested information.

The higher level application services 5200 may include software and systems that perform broader analysis of activity in a frequency band, such as managing multiple WLANs, managing a WLAN associated with one or more wireless LANs, network security for both wired and wireless LANs, etc. These applications may call upon the services of any one or more of the software processes shown on the other side of the NSI 5150.

There are many applications of the location measurement techniques described herein. One application is to locate devices associated with problems or security breaches, which have particular utility in large multiple-AP enterprise type WLANs. For example, if a device is determined to be operating without authority in a WLAN, its location can be determined to disable that device. A WLAN AP could attempt to go active in an existing WLAN environment using an identifier, such as a service set identifier (SSID) that is not authorized. When such an AP begins transmitting, its SSID can be captured and compared against a database of valid SSIDs to determine whether it is a valid AP. If it is not a valid AP, then its location can be determined to disable it. Similarly, if another device, such as a fraudulent STA associates with a STA masquerading as a valid STA using the MAC address of a valid STA, techniques can be used to determine if its signal pulse profile matches the signal pulse profile of the valid STA (based on stored data). When there is a mismatch, then the fraudulent STA can be located and disabled.

Still another application is to use device location as an indicator of whether the device is a valid or authorized device. For example, a so called “parking lot” attack on a WLAN occurs when a device outside the normal perimeter of a building associates with a WLAN inside a building or premises, possibly breaching security to a wired network server. The location of all devices in a WLAN can be tracked. If a device is outside a predetermined boundary, an alert can be generated that indicates a possible unauthorized device receiving signals on the WLAN. FIG. 14 shows an example for displaying on a coverage map an icon where a device has been detected outside a boundary indicated at reference numeral 1000. Actions can be taken to disable that device. It is further possible that a device may be permitted to roam further from the normal coverage area of the WLAN if it can supply a suitable password or authorization code (that matches a code in a database) in response to an request sent to the device when it is determined that its location is outside the predetermined boundary.

Similarly, the location a source of interference (of any signal type) can be located using the techniques described herein. For example, a denial-of-service attack on a wireless network may take the form of a powerful noise signal being emitted. The source of that emitter can be located using these techniques. Another example is determining the location of an interfering signal. To a WLAN, an interfering signal may be any non-WLAN signal that transmits on a periodic or aperiodic basis. When the interference or noise source is located, actions can be taken to avoid that area by other devices, or to disable the noise or interference source.

Still another application of the location measurement process is one in which APs in a WLAN may locate themselves and other APs by obtaining TDOA measurements at two or more other APs at known locations. An AP may initiate the location measurement process (and sent the first signal) even if it does not know its location, as long as it can obtain sufficient TDOA measurements at two or more known locations. As a new AP location measurement is obtained, other APs whose locations are not known may exploit the other APs at known locations to locate themselves.

In sum, a method is providing for determining a location of a target device capable of transmitting a wireless radio signal based on a first time difference between arrival of a first signal at a first known location and arrival a second signal transmitted by the target device at the first known location, and at least a second time difference between arrival of the first signal at a second known location and arrival of the second signal at the second known location. The first signal and second signals may be periodic or aperiodic. The first signal may be transmitted from a known location or an unknown location, and even a known location where the second signal is also received. Depending on information available or to be determined about the target device, as few as two TDOA measurements need to be made at two known locations, or as many as 4 measurements. Also, depending on the type of location computation process employed, two candidate locations may be produced and the correct one is selected using various techniques described herein, or a TDOA measurement can be obtained at an additional known location. On the other hand, some location computation processes, such as an iterative process, compute a single location solution.

Also described is a system for determining the location of a target device capable of transmitting a wireless radio signal, comprising first and second radio receivers located at first and second known locations, respectively, to receive wireless radio signals at the first and second known locations; and a computing device that computes the location of the target device from a first time difference between arrival of a first signal at the first known location and arrival of a second signal transmitted by the target device at the first known location and at least a second time difference between arrival of the first signal at the second known location and arrival of the second signal at the second known location. The variations described with respect to the method also apply to the system.

Further described is a processor readable medium that stores instructions, which when executed, cause the processor to perform the step of computing a location of a target device capable of transmitting a wireless radio signal based on a first time difference between arrival of a first signal received at a first known location and arrival of a second signal transmitted by the target device at the first known location, and at least a second time difference between arrival of the first signal at a second known location and arrival of the second signal at the second known location. The variations described with respect to the method also apply to the processor readable medium deployment format.

Still further described is a wireless radio device comprising a radio receiver that receives wireless radio signals; an analog-to-digital converter (ADC) coupled to the radio receiver that converts analog receive signals output by the radio receiver to digital signals; a memory coupled to the ADC that, in response to a memory store signal, stores digital signals output by the ADC; and a processor coupled to the memory and to the ADC, that generates the memory store signal to cause the memory to store data output by the ADC associated with at least one of two signals received by the radio receiver that are associated with a location measurement operation to locate a target device. Many of the variations described with respect to the method and system also apply to the wireless radio device.

Using the location techniques described herein, or any other radio location techniques, a method is provided for detecting an unauthorized wireless radio device, comprising steps of detecting a location of a wireless radio device; determining whether the location of the wireless radio device is within a predetermined region (two-dimensional area or three-dimensional volume); and declaring the wireless radio device an unauthorized device if its location is outside of the predetermined region.

The above description is intended by way of example only.

1. A method for determining a location of a target device capable of transmitting a wireless radio signal based on a first time difference between arrival of a first signal at a first known location and arrival a second signal transmitted by the target device at the first known location, and at least a second time difference between arrival of the first signal at a second known location and arrival of the second signal at the second known location.

2. The method of claim 1, and further comprising the step of transmitting the first signal.

3. The method of claim 2, and further comprising the step of transmitting the first signal from the first known location.

4. The method of claim 2, and further comprising transmitting the first signal from an unknown location.

5. The method of claim 2, wherein the target device transmits the second signal periodically, and wherein the step of transmitting comprises transmitting the first signal prior to a point in time when the target device transmits the second signal.

6. The method of claim 2, wherein the target device transmits the second signal periodically, and wherein the step of transmitting comprises transmitting the first signal subsequent a point in time when the target device transmits the second signal.

7. The method of claim 2, wherein the step of transmitting comprises periodically transmitting the first signal.

8. The method of claim 1, and further comprising the steps of receiving at least a portion of the first signal at the second known location, and receiving at least a portion of the second signal at the first known location and at the second known location.

9. The method of claim 8, and further comprising the steps of detecting at least a portion of the second signal from the target device at the first known location, and detecting at least a portion of the first signal and at least a portion of the second signal at the second known location.

10. The method of claim 9, wherein the steps of detecting comprise correlating a received waveform with a reference waveform.

11. The method of claim 8, and further comprising steps of storing at the second known location data associated with receiving the portion of the first signal and data associated with receiving the portion of the second signal, and storing at the first known location at least data associated with receiving the portion of the second signal.

12. The method of claim 11, and further comprising transmitting the data stored at the first known location and the data stored at the second known location to a computing device that computes the location of the target device using the first time difference and the second time difference.

13. The method of claim 11, wherein the step of storing at the second known location is responsive to detecting the first signal at the second known location.

14. The method of claim 11, wherein the step of storing at the first known location further comprises storing data associated with receiving at least a portion of the first signal at the first known location

15. The method of claim 14, wherein the step of storing at the first known location is responsive to detecting the first signal at the first known location.

16. The method of claim 14, wherein the step of storing is responsive to receiving a message at the first and second known locations informing those locations of impending measurements of arrival of the first and second signals.

17. The method of claim 2, wherein the step of transmitting comprises transmitting the first signal addressed to the target device, and wherein the target device transmits the second signal in response to receiving the first signal.

18. The method of claim 17, wherein the step of transmitting the first signal comprises transmitting a signal that will solicit an acknowledgement signal transmitted by the target device when the target device receives the first signal.

19. The method of claim 2, wherein the step of transmitting the first signal comprises transmitting a request-to-send (RTS) signal and wherein the target device transmits a clear-to-send (CTS) signal in response to receive the RTS signal.

20. The method of claim 1, wherein one coordinate of a three-dimensional location of the target device is known, and wherein the step of determining comprises computing a location of the target device based on the first time difference, the second time difference, and a third time difference between arrival of the first signal at the target device and transmission of the second signal from the target device.

21. The method of claim 20, and further comprising the step of determining the third time difference between arrival of the first signal at the target device and transmission of the second signal from the target device.

22. The method of claim 1, wherein one coordinate of a three-dimensional location of the target device is assumed to be known, and wherein the step of determining comprises computing a location of the target device based on the first time difference, the second time difference, and a third time difference between arrival of the first signal and arrival of the second signal at a third known location.

23. The method of claim 22, and further comprising the step of receiving at least a portion of the first signal and at least a portion of the second signal at the third known location.

24. The method of claim 1, wherein the step of determining comprises computing a location of the target device based on the first time difference, the second time difference, a third time difference between arrival of the first signal at a third known location and arrival of the second signal at the third known location, and a fourth time difference between arrival of the first signal at the target device and transmission of the second signal from the target device.

25. The method of claim 1, wherein the step of determining comprises computing a location of the target device based on the first time difference, the second time difference, a third time difference between arrival of the first signal at a third known location and arrival of the second signal at the third known location and a fourth time difference between arrival of the first signal at a fourth known location and arrival of the second signal at the fourth known location.

26. The method of claim 25, and further comprising the steps of receiving at least a portion of the first signal and at least a portion of the second signal at the third known location, and receiving at least a portion of the first signal and at least a portion of the second signal at the fourth known location.

27. The method of claim 2, wherein the step of transmitting comprises transmitting the first signal multiple times from multiple antennas of a device, each time using different transmit antenna weights.

28. The method of claim 2, wherein the step of transmitting comprises transmitting the first signal from a first antenna of a device at the first known location and receiving the first signal at a second antenna of the device at the first known location in order to determine a time of transmission of the first signal at the first known location.

29. The method of claim 1, and further comprising the step of transmitting the second signal from a first antenna of the target device and receiving the second signal at a second antenna of the target device in order to determine a time of transmission of the second signal at the target device.

30. The method of claim 2, wherein the step of transmitting comprises transmitting the first signal from at least one of first and second antennas of a device at a known location, wherein the first antenna corresponds to the first location and the second antenna corresponds to the second location.

31. The method of claim 30, wherein one coordinate of a three-dimensional location of the target device is assumed to be known, and wherein the step of determining comprises computing the location of the target device from the first time difference, the second time difference, and a third time difference between arrival of the first signal at the target device and transmission of the second signal from the target device.

32. The method of claim 30, wherein one coordinate of a three-dimensional location of the target device is assumed to be known, and wherein the step of determining comprises computing the location of the target device from the first time difference, the second time difference, and a third time difference between arrival of the first signal at a third antenna of the device and arrival of the second signal at the third antenna of the device.

33. The method of claim 30, wherein the step of determining comprises computing the location of the target device from the first time difference, the second time difference, a third time difference between arrival of the first signal at a third antenna of the device and arrival of the second signal at the third antenna of the device, and a fourth time difference between arrival of the first signal at a fourth antenna of the device and arrival of the second signal at the fourth antenna of the device.

34. The method of claim 1, and further comprising the step of detecting a beginning portion of the second signal at the first and second known locations.

35. The method of claim 34, and further comprising the step of detecting an end portion of the first signal at least the first and second known locations, and wherein the step of determining comprises computing the first and second time differences as between the end of the first signal and the beginning of the second signal.

36. The method of claim 1, and further comprising the step of transmitting a message to the first and second known location to alert them of an impending measurement of the arrival of the first and second signals.

37. The method of claim 36, and further comprising the step of capturing receive signal data at the first and second known location during a time interval corresponding to the first signal/second signal exchange.

38. The method of claim 1, and further comprising the step of determining whether the target device is a valid device operating in a wireless network based on its location.

39. The method of claim 1, wherein the step of determining produces first and second candidate locations for the target device, and further comprising the step of selecting one of the first and second candidate locations as the actual location of the target device.

40. The method of claim 39, wherein the step of selecting comprises:
a. computing an observed channel response between the target device and a plurality of antennas at each of the first and second known locations based on the second signal received at the plurality of antennas at each of the first and second known locations;
b. computing candidate channel responses between the plurality of antennas for each of at least the first and second known locations and each of the first and second candidate locations; and
c. choosing one of the first and second candidate locations that minimizes a sum-of-squares Euclidean distance between the observed channel response and the candidate channel responses for the first and second known locations, respectively.

41. The method of claim 40, wherein the step of selecting further comprises the step of normalizing the observed channel response and the candidate channel responses to unity.

42. The method of claim 39, wherein the step of selecting comprises steps of generating for each of the first and second known locations, a measure of confidence that one of the candidate locations is the actual location based on angle-of-arrival of the second signal from the target device; and combining the measures of confidence for at least the first and second known locations to select the candidate location with the greatest total measure of confidence.

43. The method of claim 1, and further comprising the steps of determining a transmit behavior of the target device, and transmitting the first signal according to the transmit behavior of the target device.

44. The method of claim 1, and further comprising the steps of classifying the target device based on transmissions of the target device, and selecting a process used to determine a time of arrival of the second signal based on the step of classifying.

45. A system for determining the location of a target device capable of transmitting a wireless radio signal, comprising:
a. first and second radio receivers that receive wireless radio signals at first and second known locations, respectively; and
b. a computing device that computes the location of the target device from a first time difference between arrival of a first signal at the first known location and arrival of a second signal transmitted by the target device at the first known location and at least a second time difference between arrival of the first signal at the second known location and arrival of the second signal at the second known location.

46. The system of claim 45, and further comprising first and second memories associated with the first and second radio receivers, respectively, each of which stores data associated with at least a portion of the first signal and when it is received and data with at least a portion of the second signal and when it is received.

47. The system of claim 46, and further comprising first and second processors associated with the first and second memories, respectively, each of which executes a correlation process on data stored in the first and second memory, respectively, to detect the first signal and the second signal, wherein the first processor computes the first time difference as a time difference between arrival of the first signal at the first known location and arrival of the second signal at the first known location, wherein the second processor computes a second time difference as a time difference between the arrival of the first signal at the second known location and arrival of the second signal at the second known location.

48. The system of claim 46, wherein the computing device receives data stored the first and second memories and executes a correlation process to detect arrival of the first signal and the second signal at the first and second known locations, respectively, and computes the first time difference and the second time difference.

49. The system of claim 48, wherein the computing selects a correlation process to detect arrival of the second signal based on a signal type determined for the second signal.

50. The system of claim 46, wherein each of the first and second memories has a storage capacity to store only a portion of the first signal sufficient to capture the end of the first signal and only a portion of the second signal sufficient to capture the beginning of the second signal.

51. The system of claim 45, and further comprising a third radio receiver at a third known location that receives the first signal and the second signal, wherein the computing device computes the location of the target device based on the first time difference, the second time difference and the third time difference.

52. The system of claim 51, and further comprising a fourth radio receiver at a fourth known location that receives the first signal and the second signal, wherein the computing device computes the location of the target device based on the first time difference, the second time difference, the third time difference and the fourth time difference.

53. The system of claim 45, and further comprising a radio transmitter that transmits the first signal.

54. The system of claim 53, wherein the radio transmitter transmits the first signal as a request-to-send (RTS) signal, and the target device transmits the second signal as a clear-to-send (CTS) signal.

55. The system of claim 45, wherein the radio transmitter transmits the first signal with information to solicit an acknowledgment signal from the target device in response to the first signal, wherein the second signal is the acknowledgment signal.

56. The system of claim 53, wherein the radio transmitter transmits the first signal as a periodic signal.

57. The system of claim 53, wherein the radio transmitter transmits the first signal before or after the second signal.

58. The system of claim 53, and further comprising a radio receiver located at a third known location together with the radio transmitter, wherein the radio receiver receives the second signal transmitted by the target device, and wherein the computing device computes the location of the target device based on the first time difference, second time difference and a third time difference between transmission of the first signal from the third location and arrival of the second signal at the third location.

59. The system of claim 45, wherein the computing device further determines whether the target device is a valid device operating in a wireless network based on its location.

60. The system of claim 45, wherein the computing device produces first and second candidate locations for the target device and selects one of the first and second candidate locations as the actual location of the target device.

61. The system of claim 60, wherein the computing device further computes an observed channel response between the target device and a plurality of antennas at each of the first and second known locations based on the second signal received at the plurality of antennas at each of the first and second known locations; computes candidate channel responses between the plurality of antennas for each of at least the first and second known locations and each of the first and second candidate locations; and chooses one of the first and second candidate locations that minimizes a sum-of-squares Euclidean distance between the observed channel response and the candidate channel responses for the first and second known locations, respectively.

62. The system of claim 60, wherein the computing device generates for each of the first and second known locations, a measure of confidence that one of the candidate locations is the actual location based on angle-of-arrival of the second signal from the target device; and combining the measures of confidence for at least the first and second known locations to select the candidate location with the greatest total measure of confidence.

63. The system of claim 45, wherein the first radio receiver is part of a first device and the second radio receiver is part of a second device, wherein the first device captures data associated with the time of arrival of the first signal and the second signal at the first radio receiver, and the second device captures data associated with the time of arrival of the first signal and the second signal at the second radio receiver, and wherein the first and second devices send the data that they captured to the computing device.

64. A processor readable medium that stores instructions, which when executed, cause the processor to perform the step of computing a location of a target device capable of transmitting a wireless radio signal based on a first time difference between arrival of a first signal received at a first known location and arrival of a second signal transmitted by the target device at the first known location, and at least a second time difference between arrival of the first signal at a second known location and arrival of the second signal at the second known location.

65. The processor readable medium of claim 64, wherein one coordinate of a three-dimensional location of the target device is assumed to be known, and further comprising instructions encoded on the medium that, when executed, cause the processor to perform the step of computing a location of the target device based on the first time difference, the second time difference, and a third time difference between arrival of the first signal at the target device and transmission of the second signal from the target device.

66. The processor readable medium of claim 64, wherein one coordinate of a three-dimensional location of the target device is assumed to be known, and further comprising instructions encoded on the medium that, when executed, cause the processor to perform the step of computing a location of the target device based on the first time difference, the second time difference, and a third time difference between arrival of the first signal arrival of the second signal at a third known location.

67. The processor readable medium of claim 64, and further comprising instructions encoded on the medium that, when executed, cause the processor to perform the step of computing a location of the target device based on the first time difference, the second time difference, a third time difference between arrival of the first signal and arrival of the second signal at a third known location, and a fourth time difference between arrival of the first signal at the target device and transmission of the second signal from the target device.

68. The processor readable medium of claim 64, and further comprising instructions encoded on the medium that, when executed, cause the processor to perform the step of computing a location of the target device based on the first time difference, the second time difference, a third time difference between arrival of the first signal and arrival of the second signal at a third known location and a fourth time difference between arrival of the first signal and arrival of the second signal at a fourth known location.

69. The processor readable medium of claim 64, and further comprising instructions encoded on the medium that, when executed, cause the processor to perform the step of determining whether the target device is a valid device operating in a wireless network based on its location.

70. The processor readable medium of claim 64, and further comprising instructions encoded on the medium that, when executed, cause the processor to perform the step of selecting one of first and second candidate locations as the actual location of the target device.

71. The processor readable medium of claim 70, wherein the instructions encoded on the medium for the step of selecting further comprise instructions that, when executed, cause the processor to steps of:
a. computing an observed channel response between the target device and a plurality of antennas at each of the first and second known locations based on the second signal received at the plurality of antennas at each of the first and second known locations;
b. computing an candidate channel responses between the plurality of antennas for each of at least the first and second known locations and each of the first and second candidate locations; and
c. choosing one of the first and second possible locations that minimizes a sum-of-squares Euclidean distance between the observed channel response and the candidate channel responses for the first and second known locations, respectively.

72. The processor readable medium of claim 71, and further comprising instructions encoded on the medium that, when executed, cause the processor to normalize the observed channel response and the candidate channel responses to unity.

73. The processor readable medium of claim 70, wherein the instructions encoded on the medium for the step of selecting further comprise instructions that, when executed, cause the processor to steps of generating for each of the first and second known locations, a measure of confidence that one of the candidate locations is the actual location based on angle-of-arrival of the second signal from the target device; and combining the measures of confidence for at least the first and second known locations to select the candidate location with the greatest total measure of confidence.

74. A wireless radio device comprising:
a. a radio receiver that receives wireless radio signals;
b. an analog-to-digital converter (ADC) coupled to the radio receiver that converts analog receive signals output by the radio receiver to digital signals;
c. a memory coupled to the ADC that, in response to a memory store signal, stores digital signals output by the ADC; and
d. a processor coupled to the memory and to the ADC, that generates the memory store signal to cause the memory to store data output by the ADC associated with at least one of two signals received by the radio receiver that are associated with a location measurement operation to locate a target device.

75. The wireless radio device of claim 74, wherein the processor generates the memory store signal in response to detecting a first signal received by the radio receiver.

76. The wireless radio device of claim 75, wherein the processor generates the memory store signal to cause the memory to store data associated with the first signal received by the radio receiver and a second signal to be received by the radio receiver subsequent the first signal.

77. The wireless radio device of claim 74, wherein the processor generates the memory store signal in response to decoding data contained in a signal received by the radio receiver that advises the device of first and second signals to be transmitted that are associated an impending location measurement operation.

78. The wireless radio device of claim 77, wherein the processor generates the memory store signal to cause the memory to store data beginning at a point in time sufficient to capture the first signal and the second signal.

79. The wireless radio device of claim 74, wherein the processor correlates data stored in the memory associated with the at least one signal with reference data to detect arrival of the signal.

80. The wireless radio device of claim 79, wherein the processor correlates data stored in the memory associated with the first and second signals received by the radio receiver with reference data to detect arrival of each of the first and second signals.

81. The wireless radio device of claim 79, wherein the processor computes a time difference between arrival of the first signal and arrival of the second signal.

82. The wireless radio device of claim 77, wherein the memory has a capacity sufficient to store data from an end portion of a first signal received by the radio receiver and a beginning portion of a second signal received by the radio receiver subsequent the first signal.

83. The wireless radio device of claim 74, and further comprising a radio transmitter and a digital-to-analog converter (DAC) coupled to the processor, wherein the processor supplies digital signals to the DAC to be converted to analog signals for transmission by the radio transmitter.

84. The wireless radio device of claim 83, wherein the processor supplies to the DAC digital signals representing a first signal to be transmitted by the radio transmitter for use in the location measurement operation.

85. The wireless radio device of claim 84, wherein the processor generates the digital signals representing the first signal in response to decoding data from a received signal instructing the device to transmit the first signal.

86. The wireless radio device of claim 85, wherein the processor generates the memory store signal to cause the memory to store data associated with a second signal to be received by the radio receiver for use in the location operation.

87. The wireless radio device of claim 86, wherein the processor computes a time difference between transmission of the first signal and arrival of the second signal.

88. The wireless radio device of claim 74, and further comprising a plurality of antennas each capable of receiving radio frequency energy and a radio receiver associated with each antenna, and wherein the memory stores data associated with receiving the first signal and the second signal at each of the plurality of antennas.

89. The wireless radio device of claim 88, wherein the processor computes time differences between arrival of a first signal at each antenna and arrival of a second signal transmitted by the target device at each antenna, and computes the location of the target device using the time differences.

90. The wireless radio device of claim 89, wherein one coordinate of the target device is assumed to be known, and wherein the processor computes the location of the target device based on a first time difference between arrival of the first signal at a first antenna and arrival of the second signal at the second first antenna, a second time difference between arrival of the first signal at a second antenna and arrival of the second signal at the second antenna, and a third time difference between arrival of the first signal at the target device and transmission of the second signal from the target device.

91. The wireless radio device of claim 88, wherein one coordinate of the target device is assumed to be known, and wherein the processor computes the location of the target device based on a first time difference between arrival of the first signal at a first antenna and arrival of the second signal at the second first antenna, a second time difference between arrival of the first signal at a second antenna and arrival of the second signal at the second antenna, and a third time difference between arrival of the first signal at a third antenna and arrival of the second signal at the third antenna.

92. The wireless radio device of claim 88, wherein the processor computes the location of the target device based on a first time difference between arrival of the first signal at a first antenna and arrival of the second signal at the second first antenna, a second time difference between arrival of the first signal at a second antenna and arrival of the second signal at the second antenna, a third time difference between arrival of the first signal at a third antenna and arrival of the second signal at the third antenna, and a fourth time difference between arrival of the first signal at the target device and transmission of the second signal from the target device.

93. The wireless radio device of claim 88, wherein the processor computes the location of the target device based on a first time difference between arrival of the first signal at a first antenna and arrival of the second signal at the second first antenna, a second time difference between arrival of the first signal at a second antenna and arrival of the second signal at the second antenna, a third time difference between arrival of the first signal at a third antenna and arrival of the second signal at the third antenna, and a fourth time difference between arrival of the first signal at a fourth antenna and arrival of the second signal at the fourth antenna.

94. A method for detecting an unauthorized wireless radio device, comprising steps of:
a. detecting a location of a wireless radio device;
b. determining whether the location of the wireless radio device is within a predetermined region; and
c. declaring the wireless radio device an unauthorized device if its location is outside of the predetermined region.

95. The method of claim 94, wherein the step of detecting a location of the wireless device is based on signals transmitted by the wireless radio device.

96. The method of claim 94, wherein the step of determining comprises determining whether the wireless radio device is within a predetermined region associated with a wireless local area network.

97. The method of claim 94, and further comprising the step of receiving a code from the wireless radio device determining whether the wireless radio device is authorized based on the code.
